(19) United States
(12) Patent Application Publication
(10) Pub. No.: US 2008/0232888 A1
(43) Pub. Date: Sep. 25, 2008

(54) Ink ribbon cartridge for a label printer

(76) Inventors: Chin-Chuan Liu, Taipei City (TW); Hung-Kun Liao, Keelung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/723,412

(22) Filed: Mar. 20, 2007

(51) Int. Cl. B41J 35/28

(52) U.S. Cl. 400/207

(57) ABSTRACT

An ink ribbon cartridge is used in a label printer, including: a frame having two opposite side boards, a top board, and a bottom board, of which the top and bottom boards are mounted to top and bottom ends of the side boards; two first pivots respectively mounted to opposing surfaces of the opposite side boards and horizontally opposite to each other; two second pivots respectively mounted to the opposing surfaces of the opposite side boards and horizontally opposite to each other, the second pivots being arranged lower than the first pivots; and two channel structures including two first guides and two second guides, which are formed on the opposing surfaces of the opposite side boards and opposite to each other so as to delimit the two channel structures for guiding a printing module of the label printer along the channel structures for coupling to the ink ribbon cartridge.

### BACKGROUND OF THE INVENTION

1. Field of the Invention

The present invention generally relates to a label printer, and in particular to the structure of an ink ribbon cartridge of the label printer.

2. The Related Arts

In a conventional label printer, an ink ribbon cartridge is fixed inside the label printer. Thus, each time the ink ribbon cartridge is to be replaced, the operation of replacing the ink ribbon cartridge is constrained by the internal structure of the label printer. The trend of miniaturization of the label printer makes the internal space of the printer substantially reduced, which in turn leads to complication of the mechanics inside the printer. Thus, it becomes troublesome of general uses to replace and mount ink ribbon cartridge into the label printer.

### SUMMARY OF THE INVENTION

Thus, the present invention is aimed to provide an ink ribbon cartridge for a label printer, which overcome the drawbacks discussed above in respect of the conventional devices.

To realize the above object, in accordance with the present invention, an ink ribbon cartridge is provided for a label printer. The ink ribbon cartridge comprises a frame having two opposite side boards, a top board, and a bottom board, of which the top and bottom boards are mounted to top and bottom ends of the side boards; two first pivots respectively mounted to opposing surfaces of the opposite side boards and horizontally opposite to each other; two second pivots respectively mounted to the opposing surfaces of the opposite side boards and horizontally opposite to each other, the second pivots being arranged lower than the first pivots; and two channel structures including two first guides and two second guides, which are formed on the opposing surfaces of the opposite side boards and opposite to each other so as to delimit the two channel structures for guiding a printing module of the label printer along the channel structures for coupling to the ink ribbon cartridge.

### BRIEF DESCRIPTION OF THE DRAWINGS

In order to clearly show and make better comprehension of these and other features and advantages of the present invention, the present invention will now be described by way of examples, with reference to a preferred embodiment illustrated in the drawings, in which:

FIG. 1 shows a perspective view of an ink ribbon cartridge for a label printer in accordance with the present invention;

FIG. 2A is a perspective view of the ink ribbon cartridge of the present invention taken in a first perspective, with the ink ribbon detached therefrom;

FIG. 2B is also a perspective view of the ink ribbon cartridge of the present invention, but taken in a second perspective, with the ink ribbon detached therefrom; and

FIG. 3 illustrates spatial relationship between the ink ribbon cartridge of the present invention and a label printer.

### DETAILED DESCRIPTION OF THE PREFERRED EMBODIMENT

An embodiment of an ink ribbon cartridge constructed in accordance with the present invention will be described hereinafter. However, it is apparent that the present invention is not limited to the specific details so described in the following and known to those having ordinary skills of the art, and the present invention is equally applicable to other embodiments and applications. Although a detailed description of the preferred embodiment of the present invention will be given as follows, the present invention can also be extensively employed in other applications whereby the scope of the present invention is defined solely by the claims that are given after the following description of a preferred embodiment of the present invention. Further, to more clearly illustrate the principles of the present invention, constituent parts constructing the present invention are not illustrated to exact scale thereof and some are exaggerated and some are omitted for simplicity.

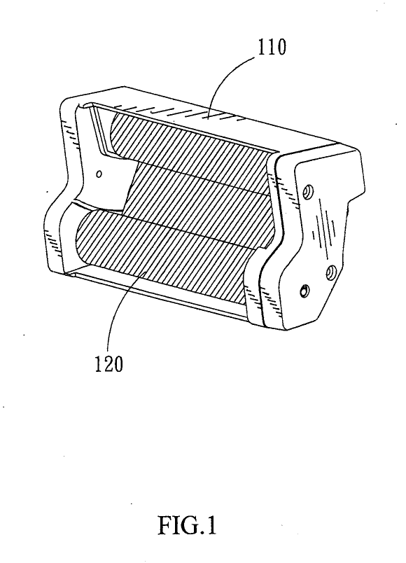

With reference to the drawings and in particular to FIG. 1, which shows a preferred embodiment of an ink ribbon cartridge of a label printer in accordance with the present invention, the ink ribbon cartridge comprises a frame 110, which comprises top and bottom boards connected by side boards. In the embodiment illustrated, the side boards are of an S-shape or an inverted L-shaped, but it is apparent that the side boards can be of different shapes. The top board and bottom board are respectively mounted to top and bottom ends of the side boards to form the frame 110. An ink ribbon 120 are wound around two rollers and the rollers are mounted to the frame 110 in an up-and-down spaced manner.

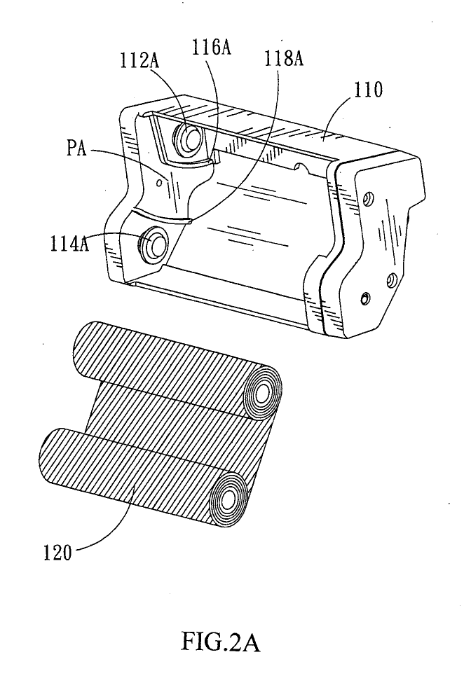

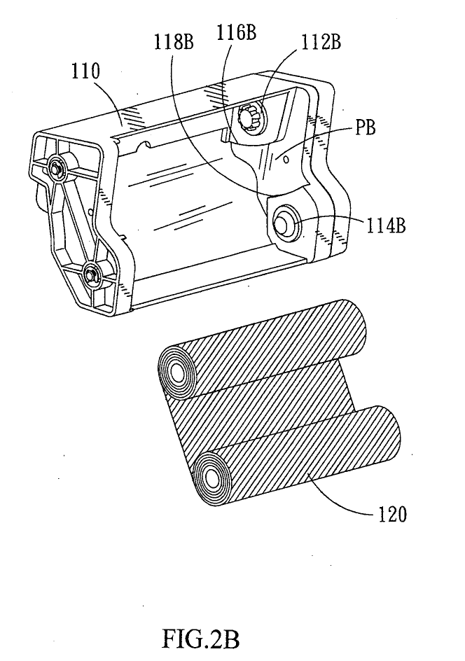

Referring to FIGS. 2A and 2B, which are perspective views of the ink ribbon cartridges of the present invention, with the ink ribbon detached therefrom, taken from different directions, the frame 110 comprises a first pivot set comprising first pivots 112A, 112B. The first pivots 112A, 112B are mounted to opposing surfaces of the opposite side boards of the frame 110 and are horizontally opposite to each other. The first pivot 112A comprises a resilient structure to allow a user to depress the first pivot 112A in a direction toward outside of the side board. The first pivot 112B is formed with a pawl-like structure to enhance gripping of the roller of ink ribbon 120. With the resilient structure of the first pivot 112A and the pawl-like structure of the first pivot 112B, the roller of the ink ribbon 120 is securely retained on the frame 110. A second pivot set includes two second pivot 114A, 114B, which are also mounted to the opposing surfaces of the opposite side boards of the frame 110, and the second pivots 114A, 114B are horizontally opposite to each other. The second pivot 114A is also provided with a resilient structure to allow a user to depress the second pivot 114A in a direction toward outside of the side board of the frame 110. The second pivot 114B provides a support on the opposite side. Thus, with the resilient structure of the second pivot 114A and the support provided by the second pivot 114B, the roller of the ink ribbon 120 can be securely retained on the frame 110. In the embodiment illustrated, the second pivot set, namely the second pivots 114A, 114B, is arranged at a horizontal location lower than that of the first pivot set, namely the first pivots 112A, 112B, so that the rollers of the ink ribbon 120 are spaced from each other and the ink ribbon 120 can be expanded across the distance between the rollers.

The frame 110 forms two channel structures PA and PB, which are preferably located between the first and second pivot sets and are delimited by two first guides 116A, 116B and two second guides 118A, 118B. The first guides 116A, 116B are formed on the opposing surfaces of the opposite side boards of the frame 110 and opposite to each other, and the second guides 118A, 118B are also formed on the opposing surfaces of the opposite side boards of the frame 110 and opposite to each other. In the embodiment illustrated, the first guides 116A, 116B are of an arc shape, while the second guides 118A, 118B are parallel to and follow the contour of the first guides 116A, 116B to define therebetween the channel structures PA, PB along which a printing module of the printer is put into and thus coupled to the frame 110. It is apparent that the shape and structure of the channel structures PA, PB can be modified in accordance with the printing module adopted. For example, the first guides 116A, 116B can be both raised ribs of curved configuration or one of the first guide rib is a raised rib, while the other one is a recessed slot. Similarly, the second guides 118A, 118B can be both raised ribs or one of the second guide is a raised rib, while the other one is a recessed slot. The channel structures PA, PB can be selectively in the form of recessed channels.

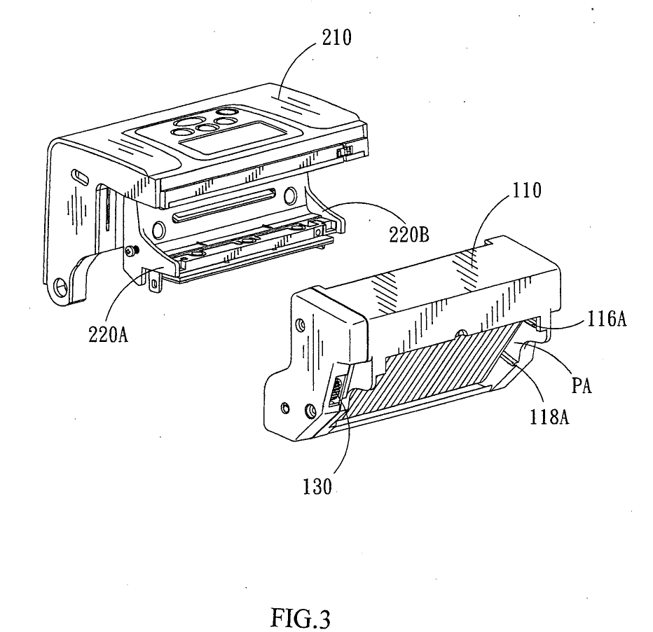

With reference to FIG. 3, which illustrates spatial relationship between the ink ribbon cartridge of the present invention and a label printer, a combined assembly 210 of a panel of the label printer and a printing device comprises two guide devices 220A, 220B corresponding to the channel structures PA, PB of the frame 110. With the guide devices 220A, 220B received in and moving along the channel structures PA, PB, the ink ribbon cartridge can be coupled to the combined assembly 210 of the label printer panel and the printing device. Further, the frame 110 comprises a drive device 130, which is operatively engageable with the first pivot 112B to transmit mechanical power to the first pivot 112B. It is apparent to those having ordinary skills to provide the frame 110 with two drive devices 130, which are respectively and operatively engageable with the first pivots 112A, 112B for applying mechanical power to the first pivots 112A, 112B. The drive device 130 can be of any known structure, such as gear-based device, belt-based device, or chain based device.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. An ink ribbon cartridge for a label printer, comprising:
a frame comprising two opposite side boards, a top board, and a bottom board, the top and bottom boards being mounted to top and bottom ends of the side boards;
a first pivot set, comprising two first pivots respectively mounted to opposing surfaces of the opposite side boards and horizontally opposite to each other;
a second pivot set, comprising two second pivots, respectively mounted to the opposing surfaces of the opposite side boards and horizontally opposite to each other, the second pivot set being arranged at a horizontal location lower than the first pivot set; and
two channel structures comprising two first guides and two second guides, the first guides being formed on the opposing surfaces of the opposite side boards and opposite to each other, the second guides being formed on the opposing surfaces of the opposite side boards and opposite to each other so as to delimit the two channel structures for guiding a printing module of the label printer along the channel structures for coupling to the ink ribbon cartridge.

2. The ink ribbon cartridge as claimed in claim 1, wherein the side boards are of an inverted L-shape.

3. The ink ribbon cartridge as claimed in claim 1, wherein the side boards are of an S-shape.

4. The ink ribbon cartridge as claimed in claim 1, wherein one of the first pivots comprises a resilient structure, by which said one of the first pivots is depressible in a direction toward outside the associated side board.

5. The ink ribbon cartridge as claimed in claim 1, wherein one of the first pivots comprises a pawl-like structure, which enhances gripping with a roller of an ink ribbon.

6. The ink ribbon cartridge as claimed in claim 1, wherein one of the second pivots comprises a resilient structure, by which said one of the second pivots is depressible in a direction toward outside the associated side board.

7. The ink ribbon cartridge as claimed in claim 1, wherein the channel structures are arranged between the first and second pivot sets.

8. The ink ribbon cartridge as claimed in claim 1, wherein the first guides comprise two raised ribs.

9. The ink ribbon cartridge as claimed in claim 1, wherein the one of the first guides comprises a raised rib, while the other one of the first guides comprises a recessed slot.

10. The ink ribbon cartridge as claimed in claim 1, wherein the second guides comprise two raised ribs.

11. The ink ribbon cartridge as claimed in claim 1, wherein the one of the first guides comprises a raised rib, while the other one of the first guides comprises a recessed slot.

12. The ink ribbon cartridge as claimed in claim 1, wherein one of the channel structures comprises a recessed channel.

13. The ink ribbon cartridge as claimed in claim 1 further comprising a drive device operatively engageable with one of the first pivots to apply mechanical power to the first pivot.

14. The ink ribbon cartridge as claimed in claim 1 further comprising two drive devices respectively and operatively engageable with the first pivots to apply mechanical power to the first pivots.
